(19) United States
(12) Patent Application Publication
(10) Pub. No.: US 2006/0229787 A1
(43) Pub. Date: Oct. 12, 2006

(54) Electro-hydraulic control process and work machine using same

(76) Inventors: Prasaad B. Kurup, Apex, NC (US); Brian D. Horton, Cary, NC (US)

Correspondence Address: Michael B. McNeil;Liell & McNeil Attorneys PC, P.O. Box 2417, Bloomington, IN, 47402, US

(21) Appl. No.: 11/102,282

(22) Filed: Apr. 8, 2005

(51) Int. Cl. G06F 19/00

(52) U.S. Cl. 701/50

(57) ABSTRACT

A method of controlling an electro-hydraulic system is provided. The method includes receiving an input corresponding to an operator commanded adjustment of the system, and determining an output at a time increment to adjust the electro-hydraulic system based at least in part on the input, at least one output at a previous time increment and at least one predetermined damping constant. A work machine and method of preparing an electro-hydraulic system of a work machine for operation are also provided. The work machine includes an electro-hydraulic system with at least one movable control member, a manual input device and an electronic controller. The electronic controller includes a control algorithm for generating an output to adjust the position of the at least one movable control member. The method of preparing includes determining a damping constant for damping a response of the electro-hydraulic system, and programming an electronic controller of the work machine with a control algorithm for controlling the hydraulic system, and adjusting a position of the control member based at least in part on the at least one damping constant.

### TECHNICAL FIELD

The present disclosure relates generally to electro-hydraulic control processes, and relates more particularly to a control process that artificially damps the response of a hydraulic system to an operator commanded adjustment.

### BACKGROUND

Hydraulic systems are core components of many familiar work machines. For example, virtually all cranes, off-highway work machines, track-type and wheeled tractors and loaders include hydraulic systems for actuating their various implements. In a wheel loader, for example, the hydraulic system may be used to actuate hydraulic cylinders coupled with the bucket, for both raising/lowering and tilting. In a common traditional design, the wheel loader is equipped with manual controls inside an operator cab. A control lever, for example, allows an operator to control a flow of fluid into and out of one or more hydraulic cylinders, typically by adjusting the position of a pilot valve and thereby adjusting a fluid flow direction between the hydraulic cylinder(s) and a hydraulic pump.

Pilot-operated hydraulic systems are often termed “hydromechanical” systems, and many designs have seen great commercial success over the years. More recently, however, designers have increasingly experimented with electronically controlled or “electro-hydraulic” systems. While such systems offer numerous advantages, many operators have a long-developed preference for the feel and performance of a traditional hydromechanical system. In particular, operators with many hours of experience on hydromechanical systems have come to expect a certain “damping” of commands to the hydraulic system. In a typical pilot-operated hydromechanical design, each time an operator adjusts a control lever, for example, there is an inherent time lag between lever movement, pilot pressure adjustment, and the consequent displacement of a slave valve to actuate the hydraulic cylinders.

While electro-hydraulic systems also have inherent time lags, or damping, the lag between an operator commanding an adjustment in the hydraulic system and an electronic controller actually effecting an adjustment in the system tends to be inherently smaller than in similar hydromechanical systems. Skilled operators who attempt to operate many newer electro-hydraulic systems often find the systems to be too quick or too slow, or otherwise perceive them to have undesirable operating characteristics. Where an operator is uncomfortable or even merely dissatisfied, efficiency and work quality may be reduced. Operator perceptions can influence purchasing decisions as well. Mastery of work machine operation can take many hours, and it can therefore be costly and time consuming to require operators to learn the intricacies of work machine operation all over again when presented with a newer system.

Thus, one active area of research relates to developing electro-hydraulic systems that can mimic the “feel” and operation of more traditional, hydromechanical designs. For instance, in one known design, an electronic controller is programmed to delay generating or sending a control signal to a pilot valve actuator in the hydraulic system, known in the art as “rate limiting.” The intention in such an approach is to slow down the response of the electro-hydraulic system to an operator input, attempting to mimic a time lag that might occur in a traditional hydromechanical design. A set of values or modulation maps of what an electronic controller output should be at a given position of the input controller may be programmed into the controller software. Many newer electro-hydraulic systems utilize as input controllers relatively low effort/low travel control devices such as joystick control levers. Direct output based on a modulation map in such systems tends to be too fast and difficult to control in response to operator inputs. As a result, many such systems are prone to operator-induced oscillations and overshoot or undershoot of the implement response the operator is attempting to control.

To address the above challenges, “tuning” is typically required of the specific electro-hydraulic control system to accommodate operator preferences. Skilled operators having fairly reliably repeatable performance may be tasked with performing a particular operation. By varying the response rate of the hydraulic system to varying operator inputs, a technician can record one or more operators' stated preferences as to responsiveness and overall feel of the system. A skilled operator may be tasked with repeatedly commanding most, if not all of the possible adjustments of the system many times. For instance, an operator may execute a “lift” command to the electro-hydraulic system numerous times, a technician varying the lag between command and response until the operator reports that the response “feels” right. Multiple skilled operators are typically employed to arrive at the general rate limits that will be employed in the system. Moreover, each variety of movement, for example “lift” versus “tilt” may require its own degree of rate limiting. The entire process typically results in extensive data sets. Such approaches have met with some success, however, the tuning process tends to be quite time and labor intensive. Engineers are therefore continually challenged to find ways of improving upon earlier control systems, and to develop easier means for preparing such systems for operation.

The present disclosure is directed to one or more of the problems or shortcomings set forth above.

### SUMMARY OF THE DISCLOSURE

In one aspect, the present disclosure provides a method of controlling an electro-hydraulic system. The method includes the steps of, receiving an input corresponding to an operator commanded adjustment of the electro-hydraulic system, and determining an output at a time increment to adjust the electro-hydraulic system, based at least in part on the input, at least one output at a previous time increment and at least one predetermined damping constant.

In another aspect, the present disclosure provides a work machine. The work machine includes an electro-hydraulic system that includes at least one movable control member, and an operator input device. The work machine further includes an electronic controller coupled with the operator input device and configured to receive an operator input therefrom. The electronic controller includes an article with a computer readable medium having a control algorithm recorded thereon, the control algorithm including means for generating an electronic controller output at a time increment to adjust the position of the at least one movable control member, base at least in part on the operator input, at least one electronic controller output at a previous time increment, and at least one predetermined damping constant.

In still another aspect, the present disclosure provides a method of preparing an electro-hydraulic system of a work machine for operation. The method includes the step of determining at least one damping constant for damping a response of the electro-hydraulic system to at least one operator input. The method further includes the step of programming an electronic controller of the work machine with a control algorithm for controlling the hydraulic system, wherein the electronic controller is in control communication with at least one control member of the hydraulic system and with a manual input device. The control algorithm includes means for adjusting a position of the at least one control member, based at least in part on at least one electronic controller output at a previous time increment and at least one selected damping constant.

### BRIEF DESCRIPTION OF THE DRAWINGS

FIG. 1 is a side diagrammatic view of a work machine according to the present disclosure;

FIG. 2 is a schematic illustration of an electro-hydraulic system according to the present disclosure;

FIG. 3 is a flow chart illustrating a control process for an electro-hydraulic system according to the present disclosure;

FIG. 4(a) is a list of alternative equations that may be implemented in a process or control algorithm according to the present disclosure;

FIG. 4(b) is a list of alternative equations that may be implemented in a process or control algorithm according to the present disclosure.

### DETAILED DESCRIPTION

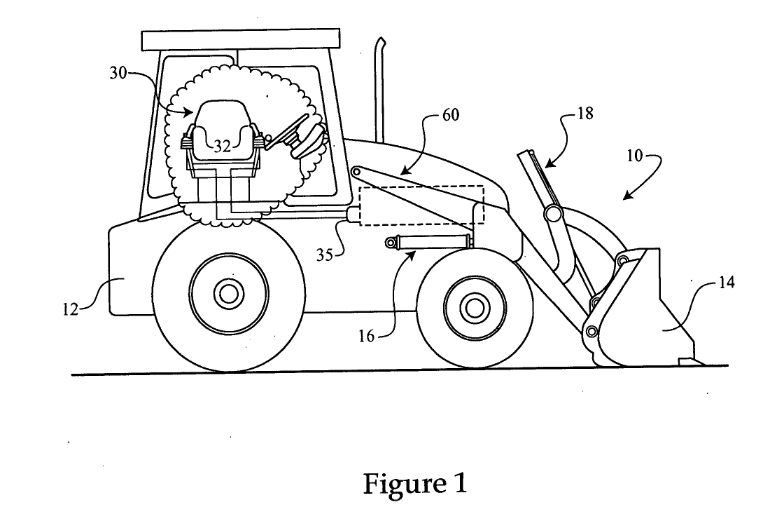

Referring to FIG. 1, there is shown a work machine 10 according to one embodiment of the present disclosure. Work machine 10 includes a work machine body 12 having a movable implement 14 such as a bucket coupled thereto. Work machine 10 may further include a manual operator input device 30, such as a pair of seat mounted control levers or joysticks 32. It should be appreciated that while dual control levers 32 are illustrated, alternatives are contemplated such as push buttons, a single control lever, or any other suitable means for inputting an operator's desired commands for work machine 10. Operator input device 30 will typically be operably coupled with an electronic control module 35. Electronic controller 35 is in turn part of an electro-hydraulic system 60, and may be in control communication with input device 30, as well as the other components of electro-hydraulic system 60, allowing an operator to request an adjustment thereto, as described herein. In one contemplated embodiment, electro-hydraulic system 60 may include a raise/lower hydraulic actuator 16 such that an operator can control raising and lowering of bucket 14 via levers 32. Electro-hydraulic system 60 may further include a tilt hydraulic actuator 18 to adjust a tilt position of bucket 14. Although work machine 10 is shown in the context of a wheel loader, those skilled in the art will appreciate that work machine 10 may be any of a broad spectrum of work machines or stationary systems that include electro-hydraulic systems.

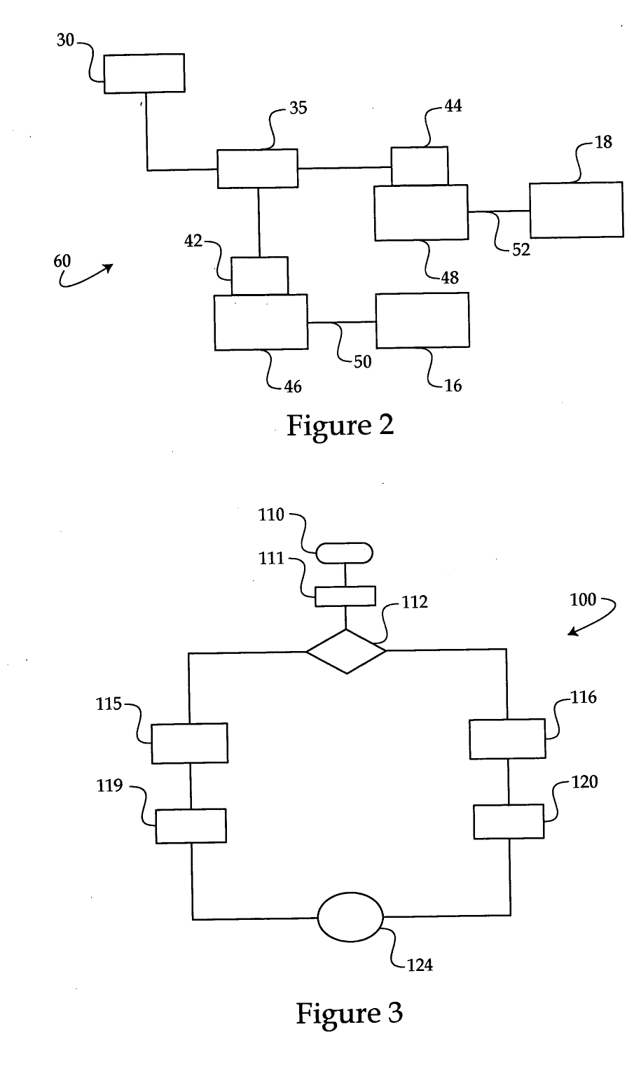

Turning to FIG. 2, there is shown a schematic illustration of electro-hydraulic system 60. System 60 may include operator input device 30, operably coupled with electronic controller 35, which is configured to receive an operator input from input device 30. Electronic controller 35 may in turn be operably coupled with a first electrical actuator 42 and a second electrical actuator 44. Each of electrical actuators 42 and 44 may be, for instance, a solenoid actuator, but might also be another type of actuator such as a piezoelectric actuator. Each of electrical actuators 42 and 44 will typically be operably coupled with a movable control member such as a pilot valve 46 and 48, respectively, that is operable to control a flow of hydraulic fluid to one of hydraulic actuators 16 and 18, via first and second fluid passages 50 and 52, respectively. A slave valve (not shown) which actually facilitates flow to the hydraulic cylinders or actuators 16, 18 may be operably coupled with each of pilot valves 46 and 48 in a well known manner.

Electronic controller 35 includes a processor and may include an article having a computer readable medium such as RAM, ROM or some other suitable type of medium, with a control algorithm recorded thereon. The control algorithm may include means for determining or generating an electronic controller output at a time increment to adjust the hydraulic system, for instance, adjusting a position of one or both of pilot valves 46 and 48. The output may be based at least in part on the operator input received by electronic controller 35, at least one electronic controller output at a previous time increment and at least one predetermined damping constant. Thus, an operator may input a command by adjusting a position of one or both of control levers 32, and electronic controller 35 via the control algorithm may determine an output to either of actuators 42 and 44 to ultimately adjust fluid flow to the respective actuators 16 and 18. The output commands to actuators 42 and 44 may result in adjustment of the position of one or both of pilot valves 46 and 48, the output commands adjusting said positions after an appropriate time delay relative to the operator input, as described herein. In this general fashion, a response of system 60 to an operator input may be artificially damped by electronic controller 35 to impart a feel to the operator that may be similar to a counterpart hydromechanical design.

At least one predetermined damping constant may be applied to the output calculation for each operator input, for example a first input corresponding to commanded raising of bucket 14 and a second input corresponding to commanded lowering of bucket 14. It is contemplated that a predetermined damping constant will be utilized across a predetermined range of motion of the member whose position is being adjusted, for instance, a valve member of the respective pilot valve 46 and 48. It is further contemplated that the predetermined damping constant will typically be applicable across the entire range of motion of the respective member, although the present disclosure is not thereby limited. For instance, there might be a first damping constant for a 0-50% range of motion, and a second damping constant for the remaining 50-100% range of motion.

For example, where the operator wishes to raise bucket 14 shown in FIG. 1, he or she may make a first input at one of control levers 32, for example, pushing the respective control lever toward a forward position. The operator may make a second input to lower bucket 14 by pulling the respective control lever toward a back position. It is contemplated that the operator's command may be damped differently for raising than for lowering. Various factors may independently bear on the operator's perceived feel of control system 60, including gravity. Similarly, the first input might be a commanded raising of bucket 14, whereas a second input might be a commanded tilt or dumping of bucket 14. Thus, as described herein, the terms “first input” and “second input” should be understood to refer to different commanded adjustments in system 60.

Accordingly, electronic controller 35 might be programmed with different damping constants corresponding to raising and lowering commands. Similarly, tilt commands to adjust the tilt of bucket 14 via actuator 18 may have other damping constants than raising/lowering, as well as separate damping constants for each commanded tilt direction.

Calculation of an appropriate electronic controller output for each type of input, however, may utilize a form of the same equation. The implemented equations for each input may differ only in the selected damping constant. Moreover, the particular value of the damping constant programmed into the control logic may be varied to tune the performance of system 60 to suit particular operators or for particular applications, as described herein. It should further be appreciated that although different damping constants may be used for different inputs, embodiments are contemplated wherein the use of the same damping constant will be applicable to plural inputs, in other words plural types of commanded adjustments to system 60. For example, the difference in the various factors bearing on operator feel between raising and lowering bucket 14 might be of little importance in certain embodiments. In such an instance it would therefore be unnecessary to utilize separate damping constants for raising and lowering motions, and their corresponding input commands.

In a related vein, the behavior of system 60 may differ depending upon whether bucket 14 is loaded or unloaded. Operator commands to system 60 when bucket 14 is loaded, for instance, might be better damped with one damping constant, whereas operator commands when bucket 14 is not loaded might be best damped with another damping constant. Thus, while it is contemplated that different damping constants will be used primarily for operator inputs that differ in the direction of motion commanded or which differ in the particular hydraulic actuator to be adjusted, different damping constants might also be used for varying operating conditions.

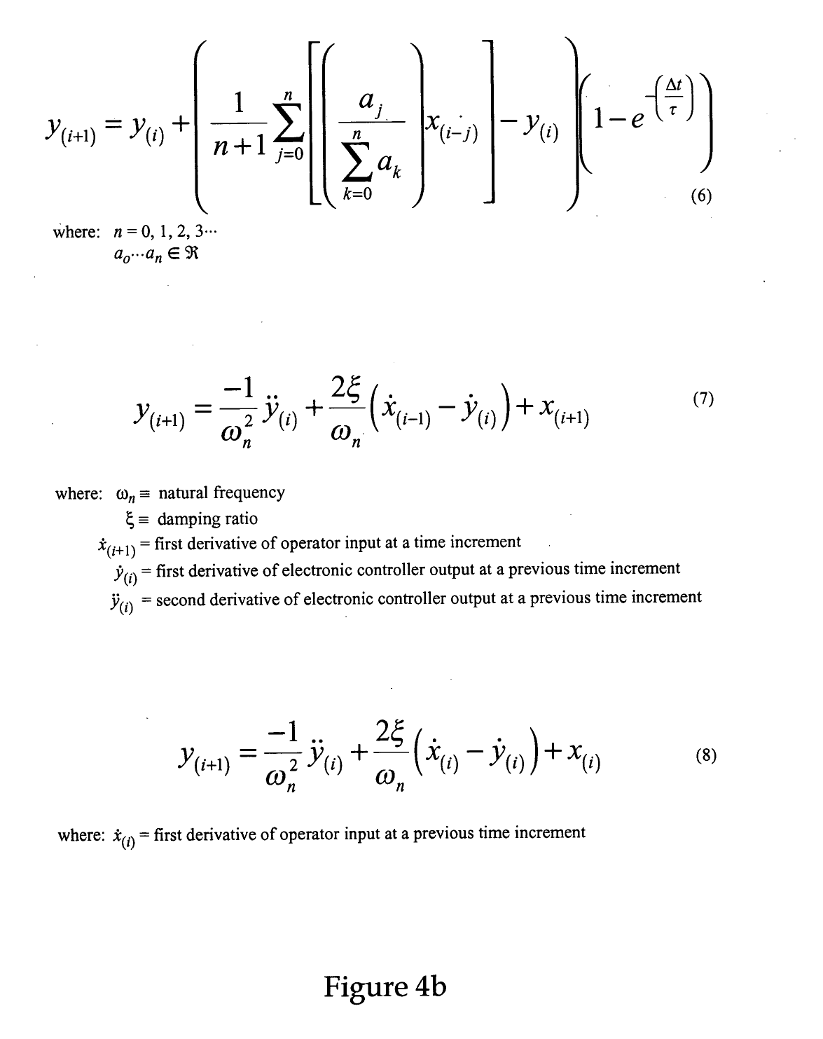

One form of the subject equation implemented in the control algorithm is as follows, also shown in FIG. 4(a) as equation (1):
y₍ᵢ₊₁₎=y₍ᵢ₎+(x₍ᵢ₊₁₎−y₍ᵢ₎)(1−e^{-Δt/τ}).

In the foregoing equation, y₍ᵢ₊₁₎ represents an actual electronic controller output, e.g. an outputted position of one of pilot valves 46 and 48 or a commanded fluid pressure or fluid flow rate to the respective hydraulical actuator, or an outputted implement speed adjustment command at a given time increment. The output may also be calculated based at least in part on a previous electronic controller output, y₍ᵢ₎ from a previous time increment, for example an immediately preceding time increment. In certain embodiments, described herein, more than one previous time increment may be used in determining the electronic controller output. It is contemplated that in at least some instances, greater accuracy in damping commanded adjustments in system 60 may be obtained by utilizing more than one previous time increment. However, those skilled in the art will appreciate that performance improvements may diminish with consideration of an increasing number of previous time increments, and the use of an electronic controller output of one immediately preceding time increment may be a practical implementation strategy.

The operator input, such as an operator commanded implement adjustment speed, valve position, or fluid pressure, will itself be factored into the determination of the electronic controller output by the control algorithm. This may take place, for instance, by utilizing in the calculation a difference between an operator command and the electronic controller output at the immediately preceding time increment, x₍ᵢ₊₁₎−y₍ᵢ₎. Where the control logic is applied in the context of adjusting a pilot valve or hydraulic pressure at a slave valve, the foregoing expression may be understood, for example, as a determination of the difference between a new adjustment commanded by the operator, or operator input at a time increment, and the previously commanded adjustment by electronic controller 35, or the electronic controller output at a previous time increment. In other words, electronic controller 35 will update the position of the pilot valve member or the subject fluid pressure to as hydraulic actuator. As described below, this updated position/pressure will be “damped” by incorporation of the term 1−e^{-Δt/τ}. In other words, rather than generating an output to immediately adjust the appropriate pilot valve, electronic controller 35 via the control algorithm may command an adjustment of the pilot valve that is less of a change than that corresponding to the actual operator input for that time increment. In this fashion, the actual output of electronic controller 35 can represent a damped response that is similar to the inherent time lagged response that would result in a hydromechanical system, by utilizing the predetermined damping constant.

As described, the term 1−e^{-Δt/τ} is a factor that incorporates the appropriate time delay into the electronic controller output. The term Δt is the time increment of the electronic controller, for instance, the time elapsed since the previous electronic controller output. It is contemplated that time increments of electronic controller 35 may be about 20 milliseconds, and may be about 5 milliseconds. Because electronic controller 35 may read the operator input as discrete step inputs, it is believed that a relatively shorter time increment, or faster update rate of adjustments commanded by the operator at input device 30, may result in a relatively smoother output signal. It is further contemplated that utilizing a time increment equal to a clock speed of electronic controller 35, or an integer multiple thereof, will be a practical implementation strategy.

The term τ represents a predetermined damping constant representative of a delay in response to an operator input from, for instance, a known hydromechanical system. In one contemplated embodiment, τ may be the time to reach 63% of a step input. A smaller τ value will give a fast response, whereas a larger value will give a slower response. τ may be determined, for example, by modeling a known hydromechanical system having acceptable or superior operating characteristics. As described herein, the damping constant is contemplated to be applicable across an entire range of motion of the movable control member which is being controlled, for example, one of pilot valves 46 and 48.

While the foregoing equation represents one means for determining the electronic controller output, alternative equations might be used apart or in conjunction with equation (1). For instance, equation (2) in FIG. 4(a) might be used with an electronic controller not capable of real time calculations. In a system utilizing equation (2), operator input could be delayed by one time increment, for instance, or by more than one time increment if desired. Use of the term x₍ᵢ₎ in equation (2) represents a delay of one time increment as compared to the term x₍ᵢ₊₁₎ in equation (1).

A running average of input commands at previous time increments might also be used, for example, utilizing equation (3) from FIG. 4(a). In equation (3), j is intended to represent a dummy variable, such that the input will be based on an average of operator inputs over a selected number of time increments n.

A further variation on the foregoing is possible utilizing equation (4) from FIG. 4(a). In equation (4), a running average of input commands at selected previous time increments may be used, with input delayed, hence the use of the term x₍ᵢ₋ⱼ₎ rather than x₍ᵢ₊₁₋ⱼ₎ as in equation (3).

A still further variation is possible using equation (5), implementing a weighted running average. Both of j and k are dummy variables allowing calculation of an average for a selected set of time increments. The variables aₒ−aₙ, which must be real, represent weighting coefficients for input commands at selected previous time increments. Utilizing equation (6) of FIG. 4(b) would allow a weighted averaged with input delayed, similar to equation (2).

Each of equations (7) and (8) of FIG. 4(b) are second order equations where, rather than a single predetermined damping constant τ, a damping ratio, represented by the Greek letter zeta, and a natural frequency, ω, are utilized, inherent in any second order system. Derivatives in equations (7) and (8) may be estimated using numerical techniques well known to those skilled in the art. Equation (8) of FIG. 4(b) represents an equation wherein input is delayed. Using a higher order equation may in some instances provide superior results, however, in many if not most systems a first order equation such as equation (1) may be adequate.

Returning to the predetermined damping constant of equation (1), one means for calculating τ will be empirically through measurements of a known system's operation that is considered to have “good” feel to its operation. In other words, a work machine having a hydromechanical system with operating characteristics, including damping, deemed acceptable or superior by skilled operators may be evaluated to determine how much delay or damping results when an operator commands an adjustment in the system. This determined or estimated numerical value may then be incorporated into the calculation performed by electronic controller 35 when calculating an appropriate electronic controller output.

To this end, the present disclosure further provides a method of preparing work machine 10 for operation. The method may include the step of, determining at least one damping constant for damping a response of the electro-hydraulic system to at least one operator input. As used herein, the term “at least one operator input” is intended to encompass work machine electro-hydraulic systems wherein only a single operator input is possible or of concern, as well as more elaborate systems wherein damping of multiple varieties of operator inputs such as different directional movements is desired. The method may further include the step of programming electronic controller 35 of work machine 10 with a control algorithm for controlling electro-hydraulic system 60. The control algorithm may include means for controlling the position of movable control member 46 or 48 to adjust a corresponding pilot valve pressure, by generating an electronic controller output as described herein.

While the present description is generally directed toward an open loop control algorithm, those skilled in the art will appreciate that a position of any of the movable components of electro-hydraulic system 60 might be used, for example, or a hydraulic pressure value to provide a feedback signal for incorporation into a closed loop control algorithm.

### INDUSTRIAL APPLICABILITY

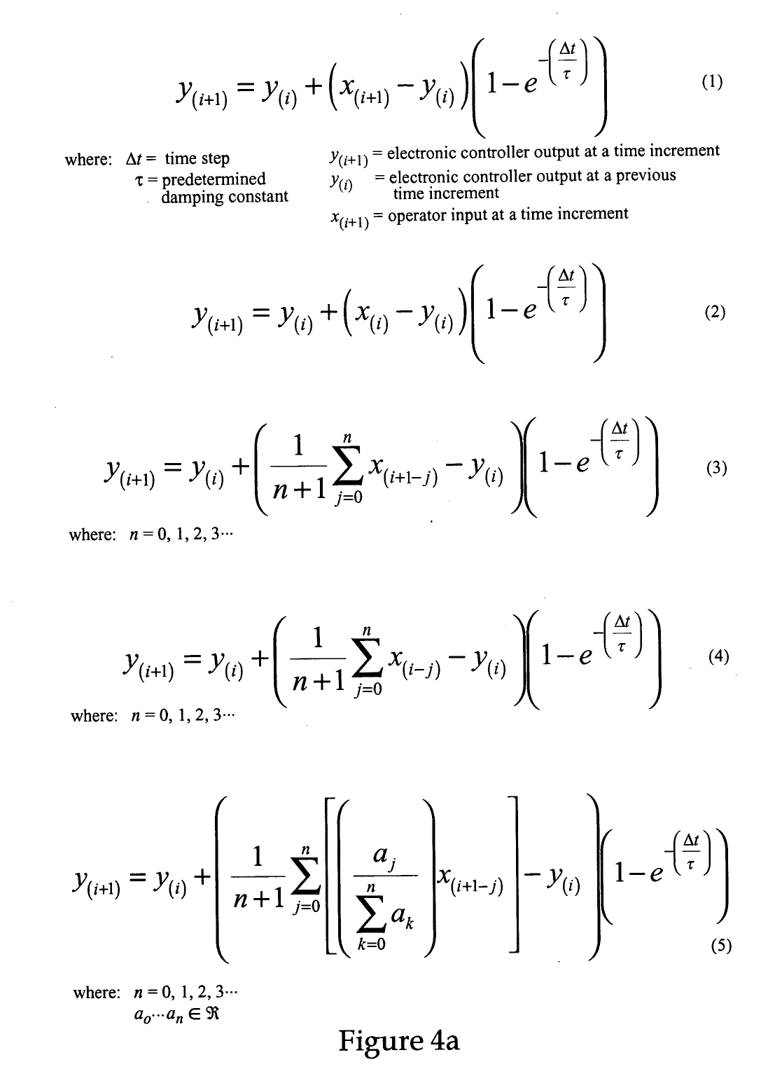

Turning to FIG. 3, there is shown a flow chart 100 representing an exemplary control process according to the present disclosure. The process begins at a START, Box 110, representing an operator input from operator input device 30. The operator adjustment to one of the control levers 32 of device 30 may be converted to an electrical current or a voltage, for example, an analog signal communicated to electronic controller 35. Electronic controller 35 may be a digital microprocessor configured to receive an analog signal or may be coupled with an analog to digital converter, for example, and, accordingly, in Box 111 the analog signal from operator input device 30 may be converted to a digital signal or value. In Box 112, electronic controller 35 may determine what adjustment the operator is commanding, for instance, whether it is a raise command, a lower command, an upward tilt command or a downward tilt command. Each of these inputs may require a different adjustment of one of pilot valves 46 and 48.

Once electronic controller 35 determines what the operator has commanded, the process may proceed to Box 115, for example for a raise or lower command or to Box 116, for example for an upward or downward tilt command. In either of Boxes 115 or 116, electronic controller 35 will determine an appropriate electronic controller output to adjust the respective pilot valve 46 or 48. The determination may include, for example, an appropriate fluid pressure command or an appropriate valve member position command. The determination may represent a current level or current on time, for example, that will be communicated to the appropriate solenoid 42 or 44.

Once the determination has been made in Box 115 or Box 116, the process may proceed to one of Boxes 119 or 120, wherein electronic controller 35 or a converter coupled therewith may generate an analog output signal to the appropriate solenoid 42 or 44. Following the output command, the process may proceed to a FINISH, Box 124.

Electronic controller 35 may continue to generate an output at each programmed time increment. Each time increment may be the input/output update rate of electronic controller 35, receiving an operator input as a step input at approximately the beginning of the time increment and generating an output at an end of the time increment. Within each time increment, electronic controller 35 determines an output based at least in part on an exponential build-up from the step input. Thus, as an operator adjusts a control lever 32, for example, electronic controller 35 will execute the control logic described herein during each time increment. Where a time increment is selected that is five milliseconds, for example, every five milliseconds electronic controller 35 will calculate an output for adjusting the position of the appropriate pilot valve, based on a position of the respective control lever. An elegance of the present approach is that a single predetermined damping constant can adaptively control the response of system 60 independent of variations in the operator's actions, for instance the speed of motion of a control lever 32. Regardless of how fast the operator is moving the control lever, the predetermined damping constant will allow a determination of the appropriate lag required in the response of the pilot valve. The predetermined damping constant can also be changed to suit particular operator needs. For instance, the present disclosure also contemplates an operator interface that would permit the operator at least some control over choosing an appropriate or desirable damping constant.

The present disclosure further provides a means for preparing an electro-hydraulic system of a work machine for operation that may be faster and simpler than traditional methods. In particular, the present disclosure provides a structured approach to developing open loop control. Rather than tuning a multiplicity of parameters in each individual electro-hydraulic system and developing a rate limiting map as in earlier designs, a single, adjustable variable (the damping constant) may be used to tune the response of the hydraulic system. Less exacting calibration of components is required at the factory, as later compensation during tuning is facilitated. Moreover, because the damping constant is based on modeling of one or a relatively small number of hydromechanical systems, the damping constants determined from such modeling may be applied to multiple work machines.

The present description is for illustrative purposes only and should not be construed to narrow the breadth of the present disclosure in any fashion. Thus, those skilled in the art will appreciate that various modifications might be made to the presently disclosed embodiment without departing from the intended spirit and scope of the present disclosure. For example, while the foregoing discussion is concerned generally with an electro-hydraulic control system and process modeled based upon a known hydromechanical design, other types of systems might serve as the model upon which the present disclosure is based. Rather than preparing a system for operation via a hydromechanical based model, a first electro-hydraulic system having desirable operating characteristics might be used to identify a predetermined damping constant for a second electro-hydraulic system, according to the present disclosure. Other aspects, features and advantages will be apparent upon an examination of the attached drawing Figures and appended claims.

What is claimed is:

1. A method of controlling an electro-hydraulic system comprising the steps of:
receiving an input corresponding to an operator commanded adjustment of the electro-hydraulic system; and
determining an output at a time increment to adjust the electro-hydraulic system, based at least in part on the input, at least one output at a previous time increment and at least one predetermined damping constant.

2. The method of claim 1 wherein the at least one predetermined damping constant comprises a first damping constant applicable across a predetermined range of motion of an electro-hydraulic control member in a first direction, and a second damping constant applicable across a predetermined range of motion of the control member in a second direction.

3. The method of claim 2 wherein each of the first and second damping constants is applicable across an entire range of motion of the control member in the respective direction.

4. The method of claim 1 wherein:
the receiving step comprises receiving a first input, and the determining step comprises determining a first output; and
the method further comprises the steps of:
receiving a second input corresponding to an operator commanded adjustment of the electro-hydraulic system; and
determining a second output at a time increment to adjust the electro-hydraulic system, based at least in part on the second input, at least one output at a previous time increment and at least one other predetermined damping constant.

5. The method of claim 4 wherein each of the determining steps comprises determining the respective output based in part on an output at an immediately preceding time increment.

6. The method of claim 5 wherein each time increment is an integer multiple of a clock speed of an electronic controller of the electro-hydraulic system.

7. The method of claim 6 wherein the determining step comprises determining the output based at least in part on the equation:
y₍ᵢ₊₁₎=y₍ᵢ₎+(x₍ᵢ₊₁₎−y₍ᵢ₎)(1−e^{-Δt/τ});
where: y₍ᵢ₊₁₎ is an electronic controller output at a time increment;
y₍ᵢ₎ is an electronic controller output at a preceding time increment;
x₍ᵢ₊₁₎ is an operator input at a time increment; and
Δt is an electronic controller time increment; and
τ is a predetermined damping constant.

8. A work machine comprising:
an electro-hydraulic system that includes at least one movable control member;
an operator input device;
an electronic controller coupled with the manual input device and configured to receive an operator input therefrom, said electronic controller having an article with a computer readable medium having a control algorithm recorded thereon, said control algorithm including means for generating an electronic controller output at a time increment to adjust the position of the at least one movable control member, based at least in part on the operator input, at least one electronic controller output at a previous time increment and at least one predetermined damping constant.

9. The work machine of claim 8 wherein the control algorithm is an open loop control algorithm.

10. The work machine of claim 9 wherein the control algorithm includes means for generating the electronic controller output based at least in part on the equation:
y₍ᵢ₊₁₎=y₍ᵢ₎+(x₍ᵢ₊₁₎−y₍ᵢ₎)(1−e^{-Δt/τ});
where:
y₍ᵢ₊₁₎ is an electronic controller output at a time increment;
y₍ᵢ₎ is an electronic controller output at a preceding time increment;
x₍ᵢ₊₁₎ is an operator input at a time increment; and
Δt is an electronic controller time increment; and
τ is a predetermined damping constant.

11. The work machine of claim 9 wherein the electronic controller output is a first output to adjust the position of a first movable control member, said control algorithm further including means for generating a second output to adjust the position of a second movable control member.

12. The work machine of claim 11 further comprising:
at least one hydraulically actuated arm operably coupled with said first movable control member; and
at least one hydraulically actuated bucket operably coupled with said second movable control member.

13. The work machine of claim 12 wherein:
said control algorithm includes means for generating said first output to adjust said first movable control member, based in part on a first damping constant; and
said control algorithm includes means for generating said second output to adjust said second movable control member, based in part on a second damping constant.

14. The work machine of claim 13 wherein said first damping constant is different from said second damping constant.

15. A method of preparing an electro-hydraulic system of a work machine for operation comprising the steps of:
determining at least one damping constant for damping a response of the electro-hydraulic system to at least one operator input;
programming an electronic controller of the work machine with a control algorithm for controlling the electro-hydraulic system, wherein the electronic controller is in control communication with at least one control member of the hydraulic system and with an operator input device, said control algorithm including means for adjusting a position of the at least one control member, based at least in part on at least one electronic controller output at a previous time increment and the at least one selected damping constant.

16. The method of claim 15 wherein the determining step comprises determining at least one damping constant that is a model based damping constant.

17. The method of claim 16 wherein the determining step comprises determining at least one damping constant that is a hydro-mechanical model based damping constant.

18. The method of claim 17 wherein the determining step further comprises determining at least two damping constants, each corresponding to a different portion of the electro-hydraulic system.

19. The method of claim 18 wherein the programming step comprises programming the electronic controller with a control algorithm including means for controlling the position of the at least one control member at least in part with the equation:
y₍ᵢ₊₁₎=y₍ᵢ₎+(x₍ᵢ₊₁₎−yᵢ)(1−e^{-Δt/τ})
where:
y₍ᵢ₊₁₎ is an electronic controller output at a time increment;
y₍ᵢ₎ is an electronic controller output at a preceding time increment;
x₍ᵢ₊₁₎ is an operator input at a time increment; and
Δt is an electronic controller time increment; and
τ is a predetermined damping constant.
